(19) United States
(12) Patent Application Publication
(10) Pub. No.: US 2017/0069033 A1
(43) Pub. Date: Mar. 9, 2017

(54) Incident Reporting Assistance System

(71) Applicants: Allan Hales, Salem, UT (US); Jason Hales, Provo, UT (US)

(72) Inventors: Allan Hales, Salem, UT (US); Jason Hales, Provo, UT (US)

(73) Assignee: Red Fox, Inc. OBA iosweep, Inc., Salem, UT (US)

(21) Appl. No.: 14/846,541

(22) Filed: Sep. 4, 2015

(51) Int. Cl. G06Q 40/08; G07C 5/00

(52) U.S. Cl. CPC G06Q 40/08; G07C 5/008; B60R 2021/0027

(57) ABSTRACT

An incident reporting assistant system may include an electronic device with a processor, memory, a data communication system, a camera and a user interface. Software may be provided on the electronic device, which may cause the electronic device to receive and display a plurality of instructional steps. This data may then be uploaded to a remote server. The instructional steps may include a classification of incident; general data, incident categories, each category including a subcategory to which a user can check if applicable to that incident, taking photos using the camera, and creating a sketch of the incident location and activity and storing the sketch in a sketch folder for review prior to uploading to the remote server. The details of an incident may be documented, reviewed and uploaded remotely from a phone or other electronic device.

### FIELD OF THE INVENTION

The present invention generally relates to vehicle incident reporting systems and, more particularly, to an incident reporting systems used in conjunction with a portable electronic device.

### BACKGROUND OF THE INVENTION

Technology is often a double edged sword. In the automotive industry, as automobiles become more advanced technologically, the comfort and crash safety of the vehicle often improves. It may also be true that this technology provides additional distractions to the driver such that the likelihood of being involved in an automotive accident may actually increase. In 2013 the fatality rate in motor vehicle accidents rose 6.7% relative to the previous year. According to the Virginia Tech Transportation Institute, engaging in the visual manual subtasks, such as reaching for a phone, dialing and texting, associated with the use of hand-held phones and other portable devices, increased the risk of getting into a crash by more than three times.

According to the national Highway traffic safety Association, published in February 2012, the injury rate per 100 million vehicle miles traveled had steadily decreased every year for more than 10 years until 2009 and 2010 where the number maintained at 75 injuries. As reported in Forbes magazine (July 2011), according to the car insurance industry estimates, the average driver will submit a collision claim once every 17.9 years. If the average driver spends 60 years behind the wheel of a vehicle, the average person will be involved in an accident 3½ times in their lifetime.

Insurance companies spend a great deal of time and money investigating and filing claims for damages as a result of vehicle accidents. In today's society, virtually every vehicle on the road has one or more hand-held electronic devices such as a cell phone, or more specifically a smart phone, onboard. This technology may provide a suitable platform to prepare, record, document and submit pertinent information to a driver's fleet manager or insurance company as the result of a vehicular accident or other roadside incident. This process would be beneficial only if it was easy to use, requires a very short learning curve, and could be operated by someone with elevated adrenaline, as may be the case immediately following involvement in, or witnessing, a roadside accident.

It should, therefore, be appreciated that there is a need for an electronic application that allows for use on a variety of electronic devices, may include GPS location and may provide easy to use visual incident reconstruction. The present invention fulfills this need and others.

### SUMMARY OF THE INVENTION

The present invention may include an incident reporting assistance system, including an electronic device, such as a cell phone, with a processor, memory, data communication system, a camera and a user interface. The software on the electronic device, which when executed by the electronic device, may cause the electronic device to receive and display a plurality of instructions and then store and communicate that data via upload to a remote server by the data communication system.

The data may be provided in accordance with the instructions, which may include the steps of providing a classification of the incident, such as an accident or other vehicle damage (e.g. a collision) and providing general data including the date and time and providing a list of incident categories. Each category in the list may include a subcategory to which a user can check if it is applicable to that incident. Further steps may include taking photos using the camera of the electronic device and storing those photos in a photo folder for review prior to being uploaded to the remote server. In addition, the step of creating a sketch of the incident location and activity may be performed. The sketch may be stored in a sketch folder for review prior to uploading to the remote server. A user may also write a summary as an additional step.

The system may include software which comprises receiving and displaying Global Positioning System (GPS) coordinates of the electronic device. This may be used in place of a user being required to put in their physical address, which may be especially beneficial if no signs are immediately visible. Any photos taken may include date/time stamps and may also include GPS coordinates.

The general data may be data selected from the group consisting of the date, the time and the location. The incident categories may include categories selected from a list consisting of road conditions, weather conditions, type of accident, the time the accident occurred, general visibility, the vehicle type and the number of vehicles involved. The list may also include additional categories and options. The system may provide the ability to add or remove categories or options, thus providing the ability to customize the system.

Selected data may be edited prior to being uploaded to the remote server. This data may include photos and the sketch. The step of creating a sketch may include the software on the electronic device providing a plurality of icons which may be selected from the group consisting of road signs, vehicles and other objects. The icons may be pulled from a menu and dropped into place on the user interface, or screen, of the electronic device.

The list of categories and subcategories may also be modified. This may be accomplished by adding or removing one or more categories or subcategories from the list of categories. For example if the user is in a tropical environment, all snow related weather options would never be used. Removing any unneeded categories or subcategories makes the process of creating a compressive incident report more efficient.

For purposes of summarizing the invention and the advantages achieved over the prior art, certain advantages of the invention have been described herein above. Of course, it is to be understood that not necessarily all such advantages can be achieved in accordance with any particular embodiment of the invention. Thus, for example, those skilled in the art will recognize that the invention can be embodied or carried out in a manner that achieves or optimizes one advantage or group of advantages as taught herein without necessarily achieving other advantages as may be taught or suggested herein.

All of these embodiments are intended to be within the scope of the invention herein disclosed. These and other embodiments of the present invention will become readily apparent to those skilled in the art from the following description of the preferred embodiments and drawings, the invention not being limited to any particular preferred embodiment(s) disclosed.

### BRIEF DESCRIPTION OF THE DRAWINGS

Embodiments of the present invention will now be described, by way of example only, with reference to the following drawings, in which:

FIG. 1 is a plan view of an electronic device displaying a start page of an incident reporting assistance system, in accordance with the present invention.

FIG. 2 is a plan view of the device shown in FIG. 1, displaying a first page on a “Report Accident/Damage” page.

FIG. 3 is a flow chart of all three potential options shown in FIG. 1.

FIG. 4 is a plan view of the electronic device as shown in FIG. 2 wherein all of the options have been completed and shown with the checkmark.

FIG. 5 is a plan view of the device as shown in FIG. 1 in a first page of the “create sketch” option.

FIG. 6 is a plan view of the device as shown in FIG. 5 and a second page of the “create sketch” option.

FIG. 7 is a plan view of the device as shown in FIG. 5 and a third page of the “create sketch” option.

FIG. 8 is a plan view of the device as shown in FIG. 5 and a fourth page of the “create sketch” option.

FIG. 9 is a list of incident categories and options related to incident details as listed in FIG. 3.

FIG. 10 is a flowchart outlining an accident assistance system in accordance with present invention, as may be used on a traditional cell phone, or similar electronic device.

### DETAILED DESCRIPTION OF THE INVENTION

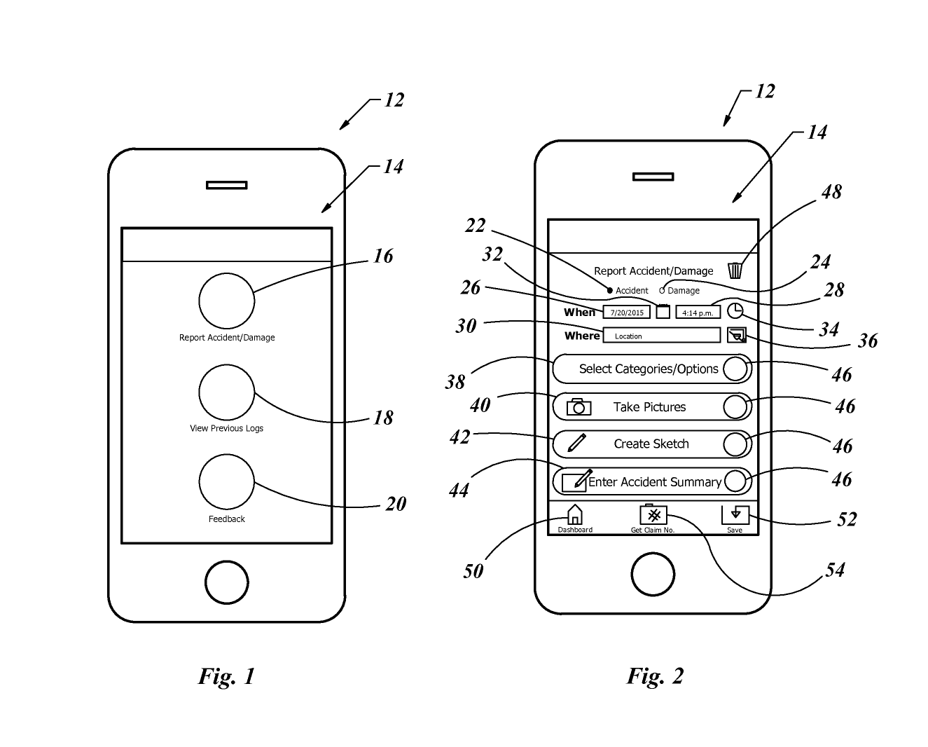

With reference to the illustrative drawings, and particularly to FIGS. 1-2, there is shown an electronic device 12 in the form of a “smart phone”. The electronic device 12 may include a user interface such as a display 14. As with this type of electronic device 12, the display 14 may be interactive in that it may be touch screen capable so that the display 14 may not only function to provide “read only” data to the user, but enable data input through touching marked areas of the display 14. In this embodiment, the display 14 may include a start page or “dashboard” with multiple potential actions. These actions may include access to the Report Accident/Damage process 16, access to View Previous Logs 18, or to provide Feedback 20 related to a report.

The Report Accident/Damage 16 action may produce a screen as shown in FIG. 2. Here the display 14 may include several features and options to assist a user in creating a comprehensive accident or damage report. The primary classification of the report as to an accident 22 or just damage 24 may be made by touching the appropriate category listed on the display 14. If a GPS feature has been activated and the electronic device 12 is GPS capable, the date 26, time 28 and location 30 may be filled in by the software in accordance with the GPS information. If no GPS signal is available or the electronic device 12 is not GPS capable, the date 26 may be added by use of the calendar icon 32 and the time 28 may be added by the clock icon 34. In a similar manner, the location 30 may be added manually or with assistance using the map icon 36.

Four main areas of interest may be presented on the display 14 of the electronic device 12 in accordance with creating a report. These may include a select categories/options icon 38, an icon to provide the ability to take photos 40 or create a sketch 42 of the accident and finally to enter an accident summary 44. By actuating any of these icons, the display 14 will move to a graphic specific to that area of interest. After inputting a level of detail in that area in that specific area of interest, a check may appear in that icon's finished box 46 indicating to the user that this area of interest has been completed by the user.

Additional actions may be provided that may be maintained on multiple display graphics of the display 14. These may include a trash icon 48, which may be used to drag and drop, or highlight and touch the trash icon, for unneeded or discarded information. A dashboard or home icon 50 may be presented to allow a one touch trip back to the start page, as shown in FIG. 1. At any time, if the user desires the information presented to be saved, the save icon 52 may be used. If the user desires a claim number for the current incident, the user may get claim number by using the claim number icon 54. This will send a message to a remote server which will in turn generate a claim number and send it to the electronic device 12 in relation to this incident.

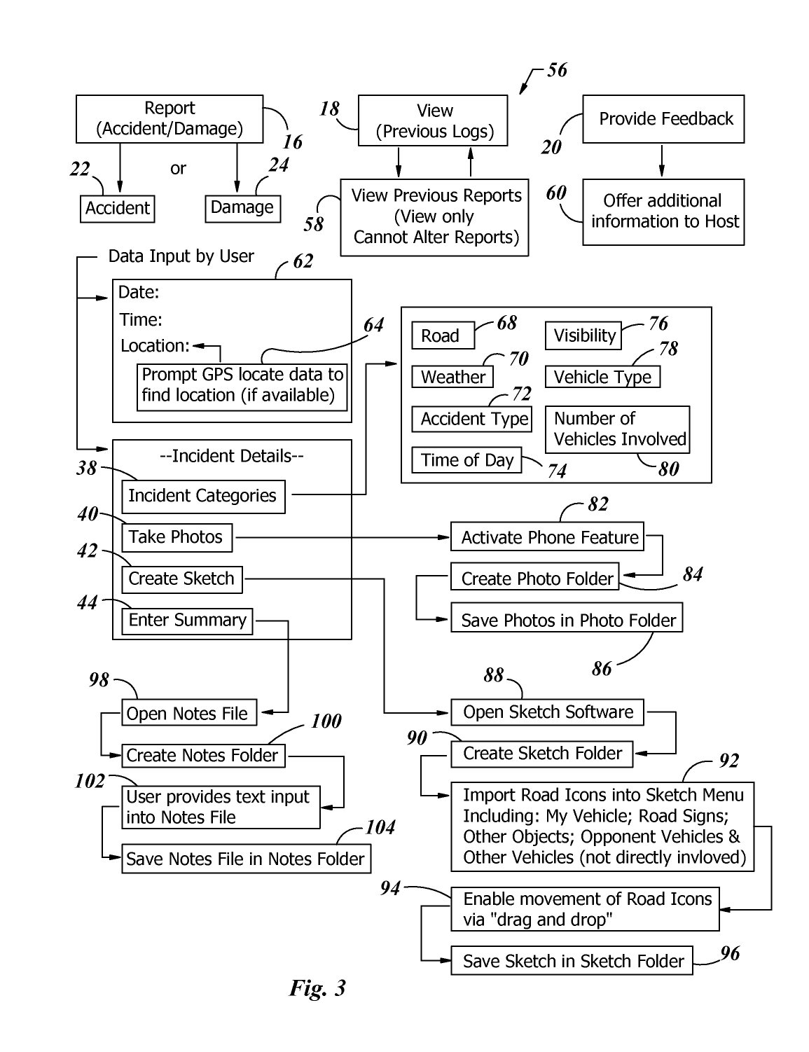

With reference to FIG. 3, a flow chart 56 is presented outlining an incident reporting assistance system as graphically shown in FIGS. 1-2. In accordance with FIG. 1 the upper section of the flowchart 56 includes the report accident/damage 16, view previous logs 18 and provide feedback 20. The view previous logs action 18 may allow the user to view previous reports 58. After a report has been submitted, a report may be provided in a view only format, wherein a previously filed report may not be altered by the user. This may allow a user to refresh their memory of a previous incident, or help to provide a format for a later incident in the case that the later incident may be similar to the previous incident. By not allowing previously submitted reports to be altered, this may reduce the probability of altering a report due to some bias or other extenuating circumstances. This may allow filed reports to be more accurate and reduce the ability of anyone to falsely alter a report for someone's benefit.

In some cases it may be desirable to provide written feedback 20 in the event that the graphic information of the traffic, roads, weather conditions etc. are not sufficient to fully tell the story accurately regarding the incident by offering additional information 60. This may be the case where something highly unusual occurred on a street or road way that would likely never happen again. For example, that may be something as simple as a driver swerved to avoid a ball that rolled into the street in front of the vehicle. This may be difficult to show graphically but with a few words can explain why the driver veered out of their lane, hit the curb and caused the flat tire. Another purpose to provide feedback 20 or additional information 60 may be for the driver to make suggestions or improvements to the accident application, which may be provided to the application developers to allow for improvements to the system.

The process as graphically illustrated in FIG. 2 may include further elements as further shown in FIG. 3. The first distinction may be for the user to generally define the incident as either an accident 22 or damage 24. It is understood that an accident may result in vehicle damage, but here it may be defined as an accident 22 involves the vehicle moving or stationary on a roadway or other environment where a driver is behind the wheel of the vehicle. Damage 24 may be defined as an event in which physical damage to the vehicle is made without a driver present. This may include vandalism, vehicle theft, and acts of nature such as a tree branch being blown out of a tree and onto the parked vehicle. It is understood that these definitions are general and are provided solely for illustrative purposes. The actual definitions may be altered without changing the intent of the invention as disclosed herein.

In the process of reporting an accident 22 or damage 24 input may be provided by the user. The first input may be the date, time and location 62 of the incident. The device 12, which may include the application system process as shown and described, may include a global positioning system (GPS) 64 which may provide the location, eliminating the need for the user to input a street or physical address. The device 12 may also include an electronic calendar and clock so that the date and time may also be provided without the need of the user to physically input this data.

After this basic data has been provided, either automatically or physically by the user, incident details may be provided. A series of incident categories 38 may be outlined to the user. The incident categories 38 may include the road type 68, the weather 70, the accident type 72, time of day 74, visibility 76, vehicle type 78 and the number of vehicles involved 80. Each one of these categories may then branch into a series of subcategories, which will be detailed later in this disclosure. It is understood that each of these categories may be altered, deleted or new categories added either by the user or the basic software package provided to the user.

The old adage that a picture is worth a thousand words may also be true in reporting an accident or other incident. As such, another method of providing incident details may be to take pictures 40. The device 12, which may be used in conjunction with this process, may include a camera feature. If the take pictures 40 feature is presented, this activates the camera feature 82 of the device 12. When the camera feature 82 is activated a photo folder 84 may be created and linked to this incident report. Any photos taken in this mode may then be saved 86 to that photo folder 84.

A variation of a picture may be a sketch. This may be very useful to tell an accurate sequence of events and use a visual aid such as a sketch of the incident. Therefore, a create sketch 42 feature may be provided. Upon actuating the create sketch feature 42, a graphic sketch software 88 may be opened. When the sketch software 88 is opened, a sketch folder 90 may also be created. A list of road icons 92 may be imported into a menu graphically shown on the sketch software 88. The road icons 92 may include my vehicle, road signs, other objects, opponent vehicles and other vehicles. The other vehicles may be vehicles in the vicinity but not directly involved with this incident. The sketch software 88 may enable the user to move the road icons on the screen of the device 12, enabling the icons to stay in a specific location in the sketch by touching that icon and dragging it to the desired location. By then removing the user's finger or stylus from the screen of the device 12 at the desired location on the screen, the icon may remain at that location on the screen of the device 12, and thereby at a location in the sketch. This may be referred to as “drag and drop” 94 as the icon is dragged and dropped in a specific location. When completed, the sketch may be saved within the sketch folder 96. The sketch folder 90 may be thereby linked to this incident report.

As previously noted in some cases a written summary may be desired to fully explain the details of a given incident. The enter summary feature 44 may be provided for that purpose. When the enter summary feature 44 is activated, a notes file 98 is opened. Concurrently a notes folder 100 is opened and also linked to this incident. The user may provide a written input 102 into the notes file 98 describing any level of detail the user feels necessary to document the incident. The notes file 98 may then be saved 104 within the notes folder 100 as a collection of data regarding that specific incident report.

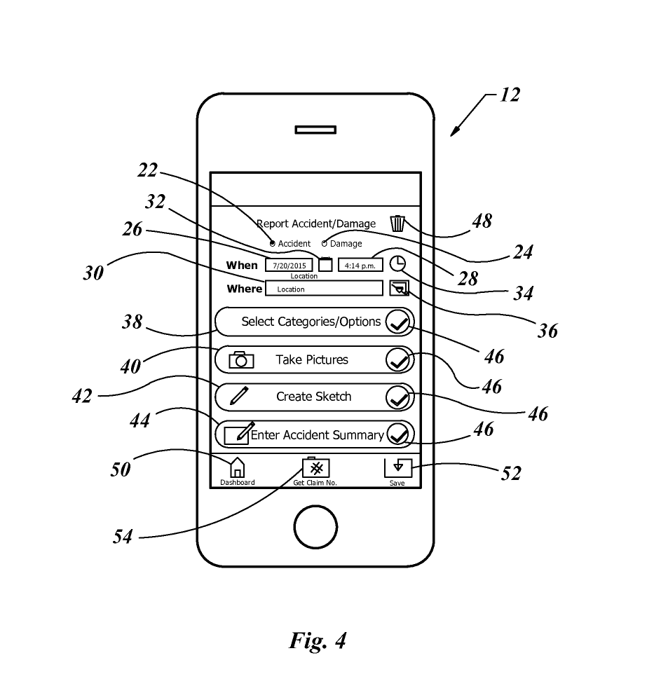

Referring to FIG. 4, the device 12 is shown as it may appear after completion of the process as previously disclosed. The device 12 may appear similar to that as shown in FIG. 2 only with a check mark in each of the finished boxes 46 of each area of interest. The check mark notes that that area of interest has been completed.

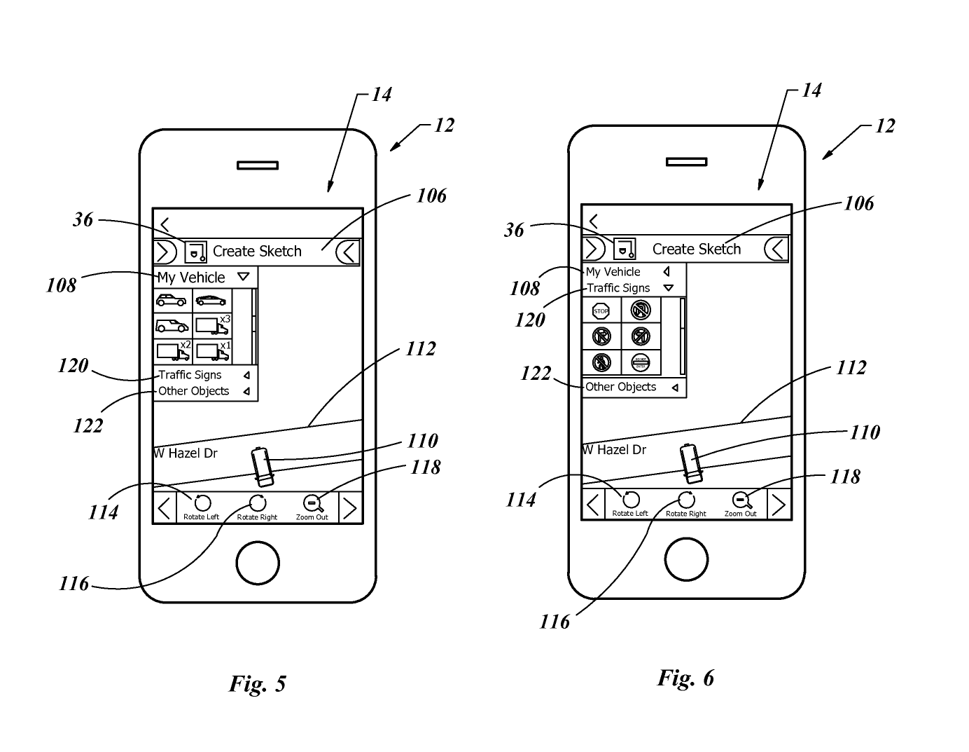

Referring to FIGS. 5-8, a graphic representation of the create sketch 42 feature is shown. The device 12 may include a display 14 with a create sketch heading 106. Also within the create sketch heading 106 the map icon 36 may also be provided. The map icon 36 may be used to assist by importing a section of map that may be used in the sketch. A menu window may open populated with one or more categories. In FIG. 5 the first category entitled my vehicle 108 may provide a series of vehicles each with a visual icon to facilitate the user's ability to identify their vehicle. As previously suggested, any vehicle icon 110 may be dragged and dropped into its proper position on the display 14 in a simulated position on the road 112. Icons, such as the vehicle icon 110, may be rotated to the left by contacting the rotate left button 114, or rotated to the right by contacting the rotate right button 116. The image of the sketch on the display 14 may be zoomed by using the zoom button 118.

In a similar manner, the second category of traffic signs 120 may be activated. As shown in FIG. 6, a menu of traffic signs may appear. As with the my vehicle icons 110, each traffic sign icon may also be moved into place and dropped into position on or near the road 112 of the sketch on the display 14. Other objects, which may include trees, rocks, telephone poles etc., may be dropped into place on or near the road 112 by activating the other objects category 122.

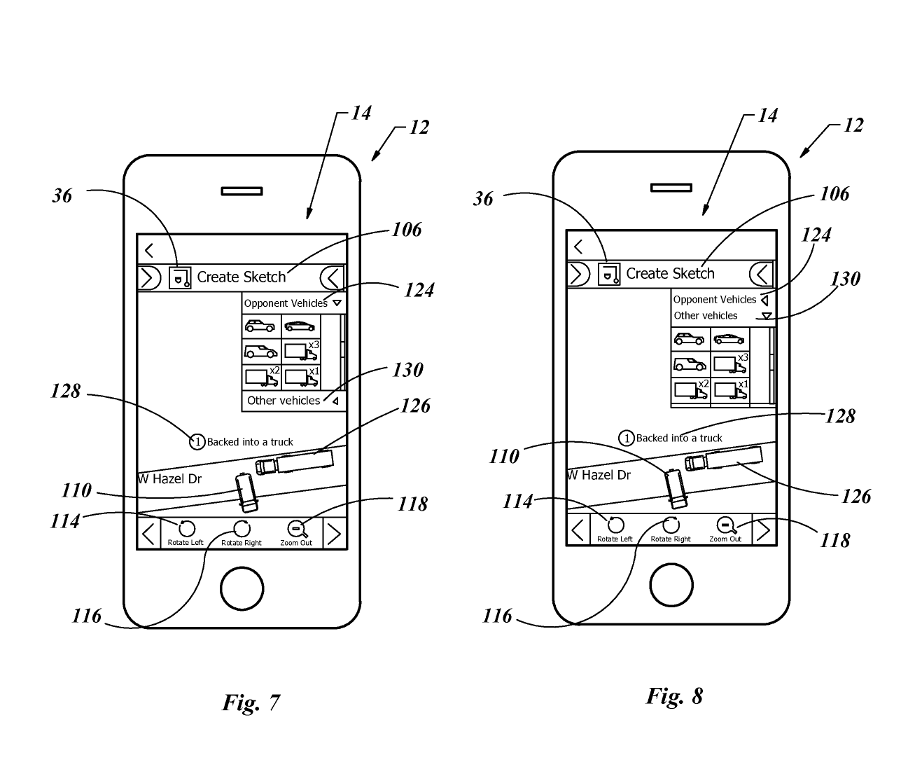

An accident typically involves another vehicle. In this application the next window to appear may be entitled opponent vehicles 124, as is shown in FIG. 7. As before, a window with a series of vehicles may appear, each of which may be selected and dropped onto the sketch at the desired location and direction to best represent the incident. Here an opponent vehicle 126 is provided showing the location and direction of movement on the sketch relative to my vehicle 110. A note 128 may be added to the sketch to further explain the actions of one or more vehicles or to identify the end result of the incident.

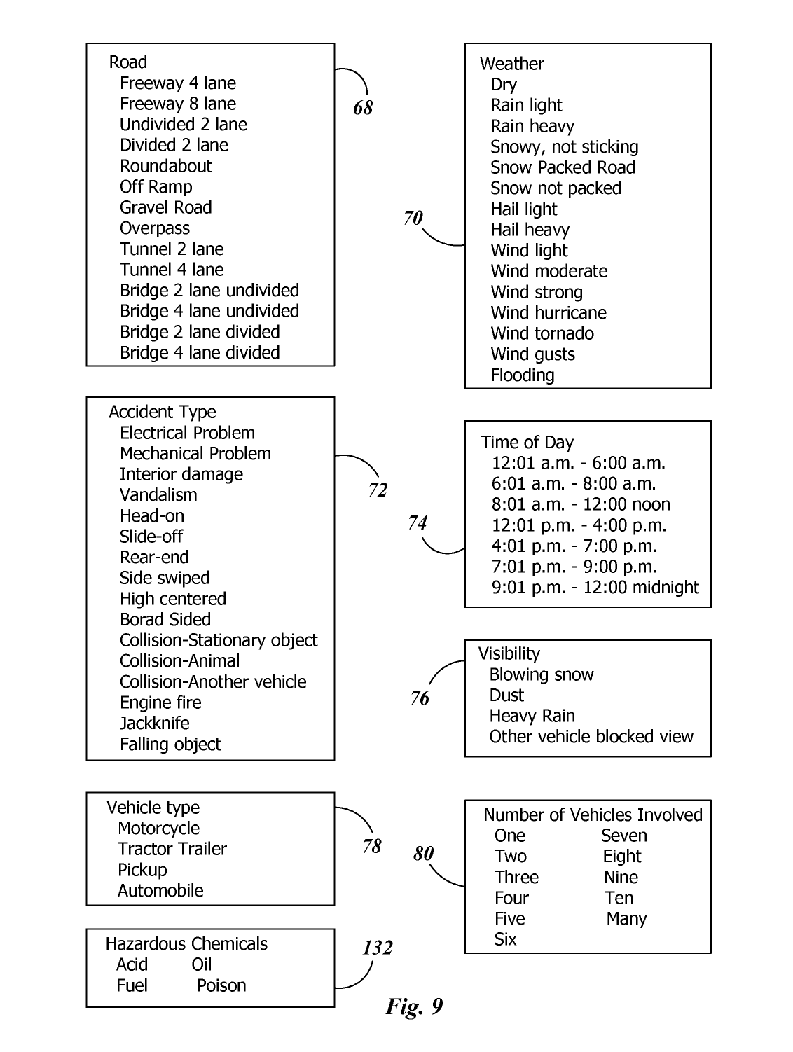

It is also common for other vehicles to be in the vicinity, though they may not have been involved in the accident. For this, the other vehicles category 130 may be activated wherein a window may be provided that includes a series of vehicles, as is presented in FIG. 8. The other vehicles may be positioned anywhere on the sketch that in any way provide input to explain details of the incident. An example may be a vehicle was parked on the side of the road and it blocked the view from my vehicle 110 in a direction so as to secure of the view of the opponent vehicle 126.

Referring to FIG. 9, a chart is presented with a list of possible subcategories in relation to each category of the select categories/options 38, as previously presented. A list of subcategories is presented for each of the categories including the road 68, whether 70, accident type 72, time of day 74, visibility 76, vehicle type 78 and number of vehicles involved 80. In addition, an additional category of hazardous chemicals 132 is also presented. It is understood that the subcategories are examples and may be added, altered or removed from the application by the user. By removing unnecessary subcategories this may greatly increase the speed and efficiency of the user in preparing a report. For example, if the user is a local truck driver on the Hawaiian island of Maui, the weather subcategories associated with snow will never be used. It may therefore be desirable for that user to remove the subcategories and possibly add a new subcategory that may be a specific possibility for someone to encounter in that area of the world.

Upon completion of a report as provided by the steps as shown and described herein, the user may upload the report to a client administrator. At this point the user may no longer modify the report but as previously noted, the user may access previous reports for review. The client administrator may contact the user for additional information or to clarify anything that the client administrator was unclear about. This process enables anyone with a telephone or other electronic device to quickly, efficiently, and effectively submit a report describing and getting detail of an accident or other incident, the user needing very little training on using the application. This time-saving and detailed submission of a report gives greater clarity of the details of the accident or incident and allows the user/driver to more quickly resume their job responsibilities.

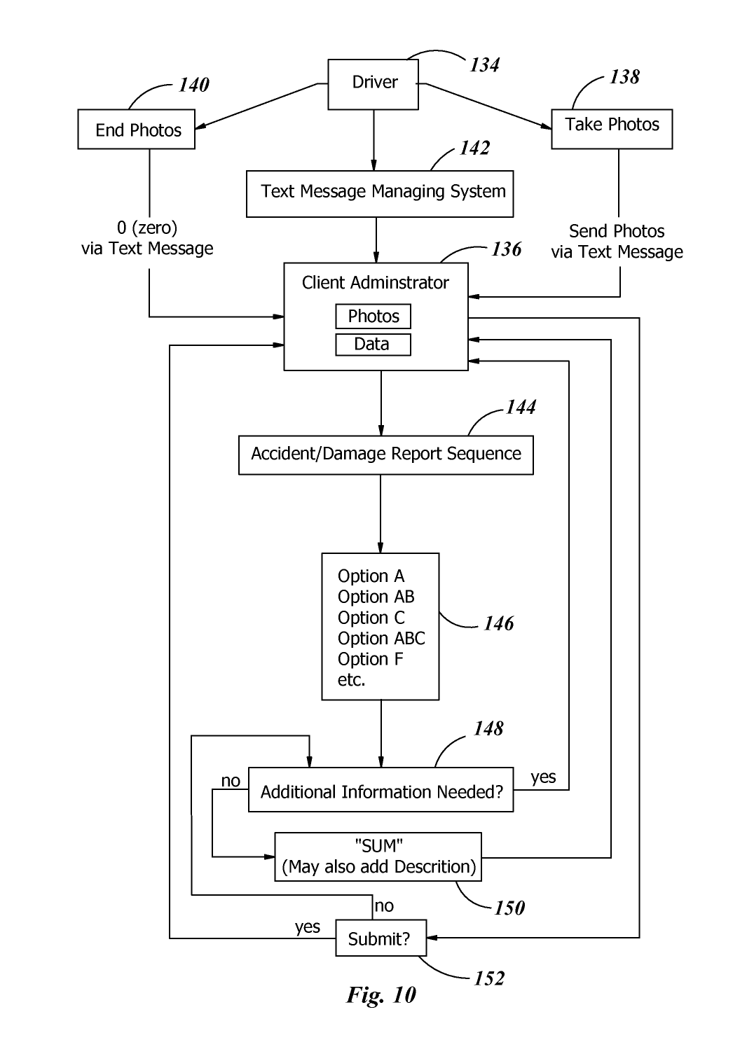

Though smart phones and tablets are relatively common in today's world, some people still have or may prefer a basic phone, such as a flip phone or other device in which the display is not capable of receiving information from the user, and a separate keypad is provided for that purpose. In FIG. 10 a flowchart is provided for which this application may be used on such a basic phone device. The user 134 may interact with the client administrator 136 by way of photos and text messages. In that a basic phone may typically only performed one action at a time, such as take photos or text message, a series of prompts may be provided by the application software on the user's basic phone. This may include a take photos prompt 138. After each photo is taken the take photos prompt 138 may be provided to the user 134 again as well as the end photos prompt 140. In this process the user 134 may continue to take photos, which will be automatically sent to the client administrator 136 until the user selects the end photos prompt 140. The rest of the information as previously provided through the use of the smartphone or tablet device 12 may be provided through the text message managing system 142.

After receiving the information, the client administrator 136 may compile the data and present it in an Accident/Damage Report Sequence 144. This information may be presented as a series of different options 146, similar to the Select Categories/Options 38 of the device in FIG. 2, only transferred to the user 134 by way of text messages. After each input, the user may be presented with the option of adding additional information 148. If more information is desired to be presented by the user 134, they respond yes, and the client administrator 136 begins the process again to present options 146 to gain the needed information. This process may be repeated as many times as necessary until the information presented is complete, when the user 134 may input the text “SUM” 150. At this point the user 134 may still add a description by way of text message. Once that process is complete, the user 134 may submit 152 the report.

The foregoing detailed description of the present invention is provided for purposes of illustration, and it is not intended to be exhaustive or to limit the invention to the particular embodiment shown. The embodiments may provide different capabilities and benefits, depending on the configuration used to implement key features of the invention.

What is claimed is:

1. An incident reporting assistance system, comprising:
an electronic device with a processor, memory, data communication capability, a camera and a user interface; and
software on the electronic device, which when executed by the electronic device, causes the electronic device to receive and display a plurality of instructions and then store and communicate data via upload to a remote server by the data communication capability, the data provided in accordance with the instructions, the instructions including the steps of:
(a) providing classification of incident;
(b) providing general data including the date and time;
(c) providing a list of incident categories, each category including a subcategory to which a user can check if applicable to that incident;
(d) taking photos using the camera of the electronic device and storing those photos in a photo folder for review prior to being uploaded to the remote server; and
(e) creating a sketch of the incident location and activity and store sketch in a sketch folder for review prior to uploading to the remote server.

2. The incident reporting assistance system according to claim 1, wherein the electronic device is a smart phone.

3. The incident reporting assistance system according to claim 1, wherein the classification of incident includes an accident or vehicular damage.

4. The incident reporting assistance system according to claim 1, wherein the software further comprises receiving and displaying GPS coordinates of the electronic device.

5. The incident reporting assistance system according to claim 1, wherein general data is data selected from the group consisting of the date, the time and the location.

6. The incident reporting assistance system according to claim 1, wherein the incident categories include categories selected from a list consisting of road conditions, weather conditions, the type of accident, the accident time, the visibility, the vehicle type and the number of vehicles involved.

7. The incident reporting assistance system according to claim 1, further comprising the step of enabling editing of data derived from steps (d) and (e).

8. The incident reporting assistance system according to claim 1, wherein the step of creating a sketch includes the software on the electronic device providing a plurality of icons.

9. The incident reporting assistance system according to claim 8, wherein the icons are selected from the group consisting of road signs, vehicles and other objects.

10. The incident reporting assistance system according to claim 8, wherein the icons are pulled from a menu and dropped into place on the user interface of the electronic device.

11. The incident reporting assistance system according to claim 1, further comprising the step of modifying the list of incident categories or subcategories, whereby unused categories or subcategories may be removed and new categories or subcategories may be added.

12. A method of reporting incident data, the method including an electronic device of the type including a processor, memory, data communication system, a camera, a user interface and software on the electronic device, which when executed by the electronic device, causes the electronic device to receive and display a plurality of instructional steps and then store and communicate data via upload to a remote server by the data communication system, the data provided in accordance with the instructional steps, including the steps of:
(a) providing classification of incident;
(b) providing general data including the date and time;
(c) providing a list of incident categories, each category including a subcategory to which a user can check if applicable to that incident;
(d) taking photos using the camera of the electronic device and storing those photos in a photo folder for review prior to being uploaded to the remote server; and
(e) creating a sketch of the incident location and activity and store sketch in a sketch folder for review prior to uploading to the remote server.

13. The incident reporting assistance system according to claim 12, wherein the electronic device is a smart phone.

14. The incident reporting assistance system according to claim 12, wherein the classification of incident includes an accident or vehicular damage.

15. The incident reporting assistance system according to claim 12, wherein the software further comprises receiving and displaying GPS coordinates of the electronic device.

16. The incident reporting assistance system according to claim 12, wherein general data is data selected from the group consisting of the date, the time and the location.

17. The incident reporting assistance system according to claim 12, wherein the incident categories include categories selected from a list consisting of road conditions, weather conditions, the type of accident, the accident time, the visibility, the vehicle type and the number of vehicles involved.

18. The incident reporting assistance system according to claim 12, further comprising the step of enabling editing of data derived from steps (d) and (e).

19. The incident reporting assistance system according to claim 12, wherein the step of creating a sketch includes the software on the electronic device providing a plurality of icons.

20. The incident reporting assistance system according to claim 19, wherein the icons are selected from the group consisting of road signs, vehicles and other objects.

21. The incident reporting assistance system according to claim 19, wherein the icons are pulled from a menu and dropped into place on the user interface of the electronic device.

22. The incident reporting assistance system according to claim 12, further comprising the step of modifying the list of incident categories or subcategories, whereby unused categories or subcategories may be removed and new categories or subcategories may be added.
